(19) United States
(12) Patent Application Publication
(10) Pub. No.: US 2014/0219947 A1
(43) Pub. Date: Aug. 7, 2014

(54) SCENT AND ULTRA-VIOLET ELIMINATION FORMULATION

(71) Applicants: Myles W. Montgomery, Cumming, GA (US); Kenneth W. Farmer, Cumming, GA (US)

(72) Inventors: Myles W. Montgomery, Cumming, GA (US); Kenneth W. Farmer, Cumming, GA (US)

(21) Appl. No.: 14/098,474

(22) Filed: Dec. 5, 2013

Related U.S. Application Data
(60) Provisional application No. 61/733,684, filed on Dec. 5, 2012.

(51) Int. Cl. A01N 47/40; D06M 13/325; A01N 33/12

(52) U.S. Cl. CPC A01N 47/40; A01N 33/12; D06M 13/325
USPC 424/76.8

(57) ABSTRACT

An odor and ultra-violet light elimination formulation for application to hunting garments and equipment. The formulation has an ultra-violet light inhibitor which absorbs ultra-violet light emissions. The formulation also has a polymer providing a protective layer against odor causing molecules. And the formulation has a quaternary ammonium for eliminating odors and serving as a liquid chemical carrier for other formulation components.

### CROSS-REFERENCE TO RELATED APPLICATION

This application claims the benefit of U.S. Provisional Application Ser. No. 61/733,684, filed on Dec. 5, 2012.

### BACKGROUND OF THE INVENTION

1. Field of the Invention

The present invention generally relates to formulations to limit the detection by animals of hunters. More particularly, the present invention relates to a formulation to limit the scent and ultra-violet light emissions of hunter's garments and persons as perceived by animals.

2. Description of the Related Art

Many wildlife game animals, in one example deer, see in ultra-violet wave lengths. Many hunters go to great measures to avoid detection by game animals. The most common method is by camouflage clothing. The camouflage clothing is effective in the human visual spectrum, but the visual spectrum of wildlife is not the same as human.

First, it is important to note how the eyes of wildlife animals perform. For example the eye of a deer, is made up of rods and cones much like a human eye. The difference between a human eye and a deer eye is the number of rods versus the number of cones. Deer have more rods and fewer cones than a human; therefore, deer have much better low light vision. Conversely, deer do not distinguish between colors as well as a human. Deer also have a pupil that opens wider than a human which allows more light in for improved night vision.

Another major difference is that deer lack the ultra-violet filtration that human eyes possess. Humans have a protective filter on their eyes that block up to 99% of ultra-violet rays. Because of the ultra-violet filter, humans are able to focus more sharply on fine details. Humans eyes can only see light in the “Visible Spectrum”, this consist of red, orange, yellow, green, blue and violet. Beyond violet light in the visible spectrum is what is known as ultraviolet light in the “Ultra-violet Spectrum”, which is light that is invisible to the human eye. The filtering of human eye however limits human's sensitivity to shortwave lengths, including those in the ultra-violet spectrum. Without the ultra-violet filter deer are limited by their ability to see fine details. However, deer see light within the ultra-violet spectrum. Humans can see the effects of ultra-violet light by using a black light to give an idea of how a deer might perceive certain surroundings. As in the deer, the eyes of many wildlife game animals such as bear, rabbit, squirrel and birds are sensitive in the ultra-violet wavelengths.

A major study by researchers and scientist at the University of Georgia concerned the visual spectrum of deer, “Visual Specialization of an Herbivore Prey Species, the White-tailed Deer” D′Angelo, et. al., Can. J. Zool. 86: 735-243 (2008), the entirety of which is hereby incorporated herein by reference. The study concluded the following:

Deer lack the cone that is responsible for red color, which are the longer wave lengths. Therefore, it is safe to say that wearing such colors as Red and Orange do not affect a hunter's ability to remain hidden from a deer's vision. This does not mean that deer do not see these colors, the colors are just perceived differently. Within the human visual spectrum, a deer's vision is limited to short length blue and middle length green wave lengths. The deer's vision means that deer can distinguish blue from red, but not green from red or orange from red. According to this data, it is safe to say that blue colors are the worst to wear for camouflage and that green, red and orange are safe to wear from a camouflage stand point for deer and most wildlife game animals. The vision spectrum of deer and human eyes is depicted in FIG. 1.

The study also found that deer are capable of seeing ultra-violet dyes and brighteners within fabrics. The study was unable to determine how bright these colors appear to the deer. The ultra-violet factor will only be of concern during low light hours. Unfortunately, this is when deer and other wildlife game animals are the most active.

### BRIEF DESCRIPTION OF THE DRAWINGS

FIG. 1 depicts the vision spectrum of Deer and Human eyes.

FIG. 2 depicts a garment under normal light.

FIG. 3 depicts the garment of FIG. 2 under black light.

FIG. 4 depicts the garment of FIG. 2 under black light after the application of the scent and ultra-violet elimination formulation to the right side of the garment.

FIG. 5 depicts the garment of FIG. 4 in normal light after the application of the scent and ultra-violet elimination formulation to the right side of the garment.

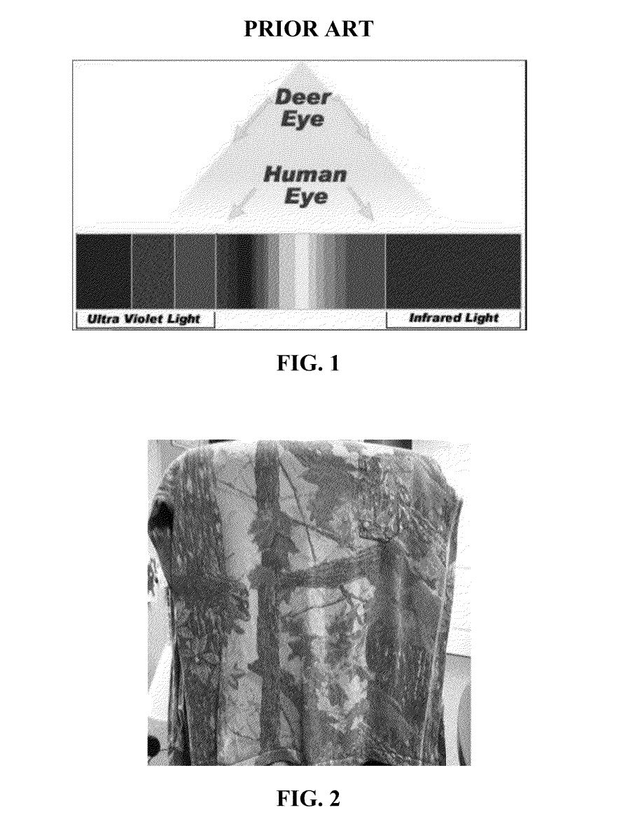

### DETAILED DESCRIPTION OF THE INVENTION

In one embodiment, the odor/scent and ultra-violet elimination formulation includes:
Propan-1,2-diol (CAS# 57-55-6):
Keeps fabrics pliable. Moisturizer/emulsifier. Lowers freezing point which is useful when hunting in extreme weather conditions.
Ethanol (CAS# 64-17-5):
General solvent. Also has antiseptic properties. Used primarily as a preservative for the formulation, increases shelf life.
Coco Alkyl Dimethylbenzyl Ammonium Chloride (CAS# 61789-71-7):
Inhibits microbial corrosion. Part of the quaternary ammonium group that acts as a biocide. Eliminates organic odors, mold and mildew.
Benzenesulfonic Acid (BZ4) (CAS# 4065-45-6):
Absorbs and blocks ultra-violet light in coatings, paper and fabrics. Also acts as a ultra-violet protectant and anti-corrosive agent.
Didecyldimethyl Ammonium Chloride (CAS# 7173-51-5):
Antiseptic/disinfectant. Part of the quaternary ammonium group. Eliminates phytopathgenic fungi, phytopathgenic bacteria and algae. Prolongs the effectiveness of odor elimination properties.
Poly (1-Hexamethylene Biguanide Hydrochloride) (CAS# 27083-27-8):

A Polymer. Provides a protective layer of protection against odor-causing molecules. The polymer builds up a defined structure that creates an inhospitable environment for odor-causing microbes. Prevents new odors from forming and airborne odors from attaching to fabric. Keeps surfaces cleaner longer. Also has antiseptic/fungicide properties.

In alternative embodiments, the odor / scent and ultra-violet elimination spray may include the ultra-violet light absorption and blocking agents:
2-Ethylhexyl salicylate (CAS# 118-60-5)
2-Propenoic acid, 3-(4-methoxyphenyl)-, 2-ethylhexyl ester (CAS# 5466-77-3)
2-Propenoic acid, 2-cyano-3, 3-diphenyl-, 2-ethythexyl ester (CAS# 6197-30-4)
Benzoic acid, 2-hydroxy-, 3,3,5-trimethylcyclohexyl ester (CAS# 11 -56-9)
2-Phenylbenzimidazole - 5 -sulfonic acid (CAS# 27503-81-7)
Oxybenzone (CAS# 131-57-7)
Avobenzone (CAS# 70356-09-1)
Zinc oxide (CAS# 1314-13-2)
Titanium dioxide (CAS# 13463-67-7

In other alternative embodiments, the odor/scent and ultra-violet elimination spray may include the quaternary ammonium compounds:
Alkyl (95%C14, 3%C12, 2%C16) Dimethyl Benzyl Ammonium Chloride CAS# 68424-85-1
Alkyl (50%C14, 40%C12, 10%C16) Dimethylbenzyl Ammonium Saccharinate CAS # 68989-01-5
Alkyl (67%C12, 25%C14, 7%C16, 1%C18) Dimethylbenzyl Ammonium Chloride CAS # 68391-01-5

In other alternative embodiments, the odor/scent and ultra-violet elimination spray may include the polymers:
Polyquaternium-6 CAS# 28301-34-0

### Claims of Use:

Scent & ultra-violet Eliminator used in the Hunting & Fishing Industry
Pet Odor Eliminator
General Household Odor/Mildew Eliminator
Odor/Mildew Eliminator for High Efficiency Washing Machines
Odor Eliminator for car/truck interiors.
ultra-violet Block Protection for premature fading of fabrics
ultra-violet Block Protection to extend the life of fabrics

Other potential uses:
Add a stain remover to formula
Add other combinations of fragrances to product
Create product in a powder or gel form
Create product pigment with the addition of color
Odor/Scent and ultra-violet Elimination Testing Information

There are several causes of odor/scent on fabric:
1. Bacteria on the skin produce volatile organic compounds (VOC's) that evaporate, pass through the fabric and cause odor.
2. Perspiration soaks into the fabric, carrying the compounds, which then evaporate and cause odor.
3. Perspiration soaks into the fabric, carrying bacteria that grow on fabric and produce compounds. These compounds evaporate and cause odor.
4. Ambient odors in one environment are absorbed by the fabric and gradually released in another environment, causing odor.

Additionally, research of the current invention show the causes of ultra-violet light emitting from fabrics:
5. Brighteners found in clothing dyes and some laundry detergents cause a Ultra-violet Glow which is perceived by wildlife such as whitetail deer.

### Product Performance

“Eliminates odors caused by bacteria”
“Proven effective against odor causing compounds”
“Creates an Invisible barrier of protection”
“Prevents new odors from forming”
“Eliminates the ultra-violet glow that animals see”
“Protects against premature fading and weathering of fabrics”

The formulation of the present invention is a liquid that is designed to be sprayed in the air, on clothing and other surfaces such as hunting blinds and vehicles, to eliminate odor and ultra-violet glow. Unlike other odor control products known in the art that only temporarily cover up odors with a masking scent, temporarily encapsulate odor, or partially absorb odor, the formulation of the present invention creates a chemical reaction that permanently eliminates odors and inhibits ultra-violet glow.

Odor from humans, pets, animals, organics, cleaning agents, etc. is caused by molecules containing chemical compounds, principally mercaptans, sulfides, nitrogen, ammonia and amines. As the formulation is sprayed either into the air or directly onto a surface containing these odors (VOC's), the formulation molecules bond to the gas molecules that cause the odor and modify them. As stated, once the reaction is complete, the odorous molecules have been altered in molecular size, weight, geometry and volatility, making them substantially scent and odor free.

The chemical reaction occurs regardless of which odor causing compounds are involved because perspiration, urine, vomit, feces, territorial spray and body contact odor all contain the same basic odor-causing molecules. Also, the chemical reaction occurs regardless of where the odor molecules reside because the reaction occurs at a molecular level and does not depend on the nature of the surface in question. So long as the formulation is able to touch and interact with the odor-causing molecules, the odor-causing molecules are eliminated. As used herein, the terms “odor” and “scent” are used interchangeably.

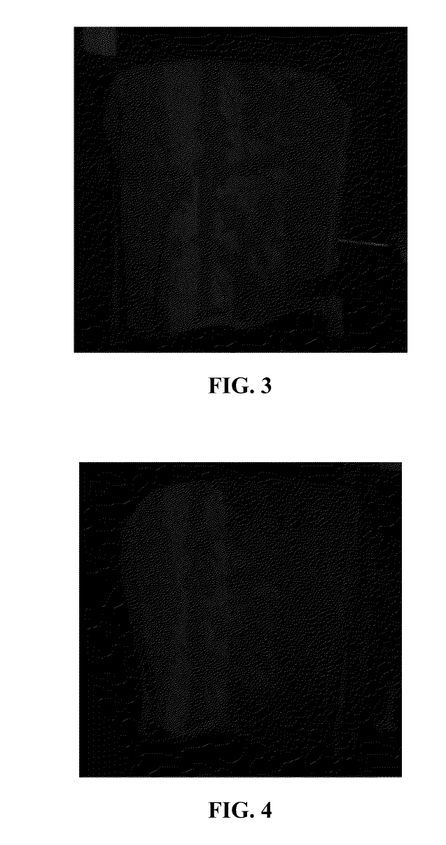

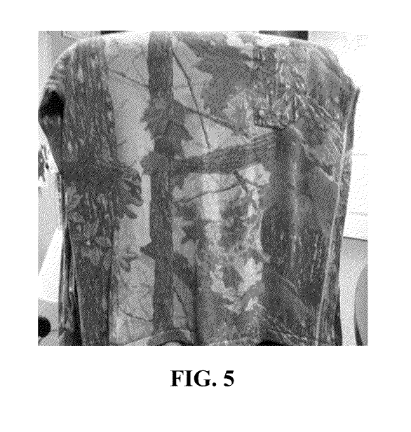

In testing of the scent and ultra-violet elimination formulation of the present invention, a new camouflage shirt was placed in a room accented with low natural light. Pictures of the garment were then taken under a black light. FIG. 2 depicts the shirt under normal light as the human eye would normally see the shirt. FIG. 3 depicts the same shirt under a black light 15 minutes after the formulation was applied to the right side only. The left side of the shirt was not sprayed with the formulation and used as the control test sample. FIG. 4 depicts the garment 30 minutes after the application of the scent and ultra-violet elimination formulation. The observer will notice that the shirt appears to be much darker and does not glow after applying the formulation spray. FIG. 5 depicts the shirt once again in normal light, after applying the formulation. In normal light, the camouflage appearance was not altered in any way. The ultra-violet inhibiting properties of the formulation will actually preserve the colors garment longer.

As seen in FIG. 4 looking at the shirt under a black light shows a dramatic difference between the side treated with the scent and ultra-violet elimination formulation and the untreated side. The contrast is enough to cause alarm for hunters who wish to do everything possible to remain hidden from the view of wildlife.

The scent elimination properties of the formulation of the present invention was tested in a series of controlled experiments. The formulation's effect on common odor-causing compounds was tested, including organic compounds that contain gases central to and consistently present in human and pet odor.

As part of the experiments, a test administrator sprayed a wide range of odor compounds with the formulation and immediately, within 15-30 seconds, took samples of the air above each substance for testing. This sample is referred to as a headspace sample. By comparing the odor profile of each sample sprayed with the formulation with the previously established odor levels emitted by each sample, the test administrator determined that spraying the formulation on the odoriferous substances immediately reduced odor levels to zero and the readings remained zero to slightly above zero over time.

In all tests, the formulation reduced the odor gases - mercaptans, sulfides and amines—to a level that could not be detected. The formulation eliminating these volatile organic compound odors as well as substantially reducing the ultra-violet glow wildlife see as presented above.

The formulation was: 1) tested in a manner that is similar to the way consumers will use the product; 2) was tested on substrates on which human odor and ultra-violet is commonly found in the outdoor industry; and 3) eliminates odors and ultra-violet glow under much more extreme conditions than the average consumer would encounter.

The odor tests were conducted in more extreme conditions than the consumer will encounter. In the laboratory tests, headspace samples were extracted at a distance of two inches from the odor-causing material. This is not a condition which consumers will encounter unless they inhale air at a similar distance from the odor causing source. Typically, a consumer will only be exposed to such odors after they dispersed into a room or vehicle.

In comparative testing, no other odor reducing products known in the art were able to reduce the odor levels of all gases to zero, either immediately or permanently. Particularly, it was noted that the encapsulation method reduced levels for methyl mercaptan.

Another test was conducted determined the ability of each product to eliminate the ammonia component of urine odor over a 10 day period. The odor eliminating formulation of the present invention was able to eliminate the ammonia component. The formulation of the present invention, when applied to extremely volatile samples of the most common source of human or pet odors, animal scents, etc. reduces odor to zero and does so permanently.

The present invention was tested by consumers spontaneously reacting to the application of the formulation to various odor bearing materials. In the study, 103 individuals were asked to smell material scented with lavender oil. Participants were then instructed to quantify the level of odor on a scale of 0 to 10, with 10 representing the most odoriferous the participant could imagine. The vast majority of participants scored the original odor level of their materials at 10. Some participants rated the materials at an 8 or 9 and none rated them below 7. Participants were then instructed to spray the materials with the odor elimination formulation. After a short time, a period of only a few seconds, the participants were asked to re-evaluate the odor emanating from the material sample. Without exception, participants rated the remaining odor as “0”.

The odor elimination formulation of the present invention reduces and eliminates the odor perceived by humans in testing. The odor and scents perceived by wildlife game animals will be similarly reduced and eliminated.

All of the compositions and process disclosed and claimed herein can be made and executed without undue experimentation in light of the present disclosure. While the compositions and process of this invention have been described in terms of preferred embodiments, it will be apparent to those of skill in the art that variations may be applied to the compositions and process described herein without departing from the concept, spirit, and scope of the invention. More specifically, it will be apparent that certain chemical compounds which are both chemically related, and similar physical characteristics, may be substituted for the chemical compounds described herein while the same or similar results would be achieved. All such similar substitutes and modifications apparent to those skilled in the art are deemed to be within the spirit, scope, and concept of the invention.

While there has been shown a preferred embodiment of the present invention, it is to be understood that certain changes may be made in the forms and arrangement of the elements of the formulation for scent and ultra-violet elimination without departing from the underlying spirit and scope of the invention.

What is claimed is:

1. An odor and ultra-violet light elimination formulation for application to hunting garments and equipment, the formulation comprising:
an ultra-violet light inhibitor, the inhibitor absorbing ultra-violet light emissions;
a polymer, the polymer providing a protective layer against odor causing molecules; and
a quaternary ammonium, the quaternary ammonia eliminating odors and being a liquid chemical carrier for other formulation components.

2. The formulation of claim 1, wherein the ultra-violet light inhibitor comprises at least one of the group: Benzenesulfonic Acid; 2-Ethylhexyl salicylate; 2-Propenoic acid, 3-(4-methoxyphenyl)-, 2-ethylhexyl ester; 2-Propenoic acid, 2-cyano-3, 3-diphenyl-, 2-ethythexyl ester; Benzoic acid, 2-hydroxy-, 3,3,5-trimethylcyclohexyl ester; 2-Phenylbenzimidazole-5-sulfonic acid; Oxybenzone; Avobenzone; Zinc oxide; and Titanium dioxide.

3. The formulation of claim 1, wherein the quaternary ammonium comprises at least one of the group: Coco Alkyl Dimethylbenzyl Ammonium Chloride, Didecyldimethyl Ammonium Chloride, Alkyl (95% C14, 3% C12, 2% C16) Dimethyl Benzyl Ammonium Chloride, Alkyl (50% C14, 40% C12, 10% C16) Dimethylbenzyl Ammonium Saccharinate , Alkyl (67% C12, 25% C14, 7% C16, 1% C18) Dimethylbenzyl Ammonium Chloride.

4. The formulation of claim 1, wherein the polymer comprises at least one of the group: 1-Hexamethylene Biguanide Hydrochloride, and Polyquaternium-6

5. The formulation of claim 1, further comprising an ethanol.

6. The formulation of claim 1, further comprising Propan-1,2-diol.

7. The formulation of claim 1, wherein the formulation is in a liquid form for spray application to the garments and equipment.

8. The formulation of claim 1, wherein the formulation is in a gel form for application to the garments and equipment.

9. The formulation of claim 1, wherein the formulation is in a powder form for application to the garments and equipment.
